(19) United States
(12) Patent Application Publication
(10) Pub. No.: US 2002/0038394 A1
(43) Pub. Date: Mar. 28, 2002

(54) USB sync-charger and methods of use related thereto

(76) Inventors: Yeong-Chang Liang, Hsin-Chu (TW); Ting Wang Lu, Hsin-Chu (TW)

Correspondence Address: OPPENHEIMER WOLFF & DONNELLY LLP, 840 NEWPORT CENTER DRIVE, SUITE 700, NEWPORT BEACH, CA, 92660, US

(21) Appl. No.: 09/813,712

(22) Filed: Mar. 21, 2001

(30) Foreign Application Priority Data
Sep. 25, 2000 (TW) 89216610

(51) Int. Cl. G06F 13/12; G06F 13/38

(52) U.S. Cl. 710/62

(57) ABSTRACT

Devices utilized for communication between a PC and a peripheral device, synchronization between the same, and supply of power to the peripheral device from the PC, are disclosed together with methods for their use. In one exemplary embodiment, a sync-charger cable accomplishes the above objectives using only the cable and its components, without the use of specialized and bulky hardware. For example, the sync-charger cable may consist of a data conversion unit operatively connected between a USB connector and a handheld device interface. The sync-charger cable operates both to exchange data and to deliver power, without utilizing an A/C adapter or a docking cradle.

### CROSS REFERENCE TO RELATED APPLICATIONS

This application claims priority to Taiwan Patent Application No. 89216610, filed Sep. 25, 2000, which application is incorporated by reference in its entirety.

### BACKGROUND OF THE INVENTION

The present invention relates to signal conversion and power supply devices. More particularly, the invention relates to Universal Serial Bus (USB) interfaces and their application to peripheral handheld devices.

The idea of making small hand-held computers for storing addresses and phone numbers, taking notes and keeping track of daily appointments originated a number of years ago. Though originally intended to become simple digital calendars, personal digital assistants (PDAs) have evolved into machines for crunching numbers, playing games or music, downloading information from the Internet, and maintaining financial information and records. However, primary computing on larger, more powerful machines remain the preferred, if not standard, mode of computing. For this reason, PDAs have not become such a staple that they have replaced desktop computers. Typically, PDAs are used as an additional, peripheral device. Not only is the use of multiple computing devices cumbersome in terms of hardware, but it also creates a necessity for keeping duplicate records and files.

With the evolution of hand-held computing technology has come the ability to provide communication between PDAs and desktop computers. When the computers are able to communicate and share information, the need for duplicate record keeping is eliminated. Unfortunately, while data management is thus streamlined, such communication typically requires additional hardware for power supply and re-charging purposes.

Because PDAs are designed to work in tandem with desktop computers, they need to work with the same information in both places. If a user jots down a phone number on his PDA, he should later upload it to his PC. Users also need to be able to save everything on the PDA to a desktop computer in case the batteries in the PDA become discharged. Communication between PDA and PC is referred to as data synchronization or syncing. This is typically done through a serial or Universal Serial Bus (USB) port, and usually involves a cradle or docking station in which the PDA sits while hooked up to the PC.

A bus, generally speaking, is a collection of wires through which data is transmitted from one part of a computer to another, or from one computer to another computer or to a peripheral device, via a port. For example, a peripheral device such as a mouse, modem, or printer, may communicate with a computer through a serial port. A serial port is an a synchronous port which transmits one bit of data at a time. Serial ports are commonly found in the majority of PC compatible computers. Typically, serial ports comprise a DB9 or a DB25 connection. These connections are defined in ISO 2110 and ISO 4902, and adhere to the RS-232C interface standard. Specifically, “D” represents the shape of the connector if placed vertically, and the number “9” or “25” indicates the number of pins in the connector.

USB external buses support data transfer rates of up to 12 Mbps, and a single USB port can be used to connect up to 127 peripheral devices, through USB hubs. Such devices can include mice, modems, and keyboards, to name a few. USB also supports plug-and-play installation and hot plugging. Plug-and-play refers to the ability of a computer system to automatically configure expansion boards and other devices. For example, devices may be connected to a USB without the need to set DIP switches, jumpers, or other configuration elements. Hot plugging is the ability to add and remove devices to a computer while the computer is running, and to have the operating system automatically recognize the change. Another important feature of USB is that the cables distribute power as well as data. The result is that devices that use modest amounts of power do not need separate power supplies.

For these reasons, the relatively new USB standardized plug and ports are expected to completely replace more traditional serial and parallel ports in computers. In this new field, however, an extensive amount of work remains in researching the ability of USB to be a compatible source for already-popular peripherals and external devices. This is especially true of external devices that require more than the modest power that USB is able to supply. Such devices include the ever-popular PDAs.

A solution to providing communication between PDA and PC while also delivering power to the PDA has been to provide PDA docking cradles or stations. These cradles provide power to the PDA by drawing the power through standard wall power outlets. Additionally, the cradles provide communication between the PDA and PC through communications ports. USB can be used for such applications. Unfortunately, docking cradles are yet another piece of cumbersome hardware for a computer user to contend with. Moreover, the AC adapters for delivering power to the PDA are cumbersome as well. The number of components typically utilized for providing communication between a PDA and a computer, and the bulky, non-portable nature of these components, cause the communication setups to be complicated, cumbersome, and difficult to transport.

### INVENTION SUMMARY

What is needed, then, is a minimal hardware solution for providing communication between a computer and a PDA and delivering power to the PDA, without requiring users to accommodate bulky AC adapters and cradles or docking stations. Accordingly, the present invention provides PDA users with a simple, low-profile and minimally hardware-dependent solution for synchronizing their PDAs and PCs through communication while delivering power to their PDAs. In view of these objectives, the present invention utilizes a small cable, connected to a low-profile signal conversion device, to transfer data and power between PDA and PC without the need for bulky docking stations or AC adapters.

### BRIEF DESCRIPTION OF THE DRAWINGS

FIG. 1 illustrates a an exemplary USB to PDA sync-charger embodiment of the present invention.

FIG. 2 illustrates a working configuration of PDA to PC communication using the exemplary USB to PDA sync-charger of the present invention.

FIG. 3 illustrates an exemplary signal conversion device embodiment of the present invention.

FIG. 4 illustrates exemplary data and power flow according to an embodiment of the invention.

### DETAILED DESCRIPTION OF THE PREFERRED EMBODIMENTS

In the following description of the preferred embodiments reference is made to the accompanying drawings which form a part thereof, and in which are shown by way of illustration specific embodiments in which the invention may be practiced. It is to be understood that other embodiments may be utilized and structural and functional changes may be made without departing from the scope of the present invention.

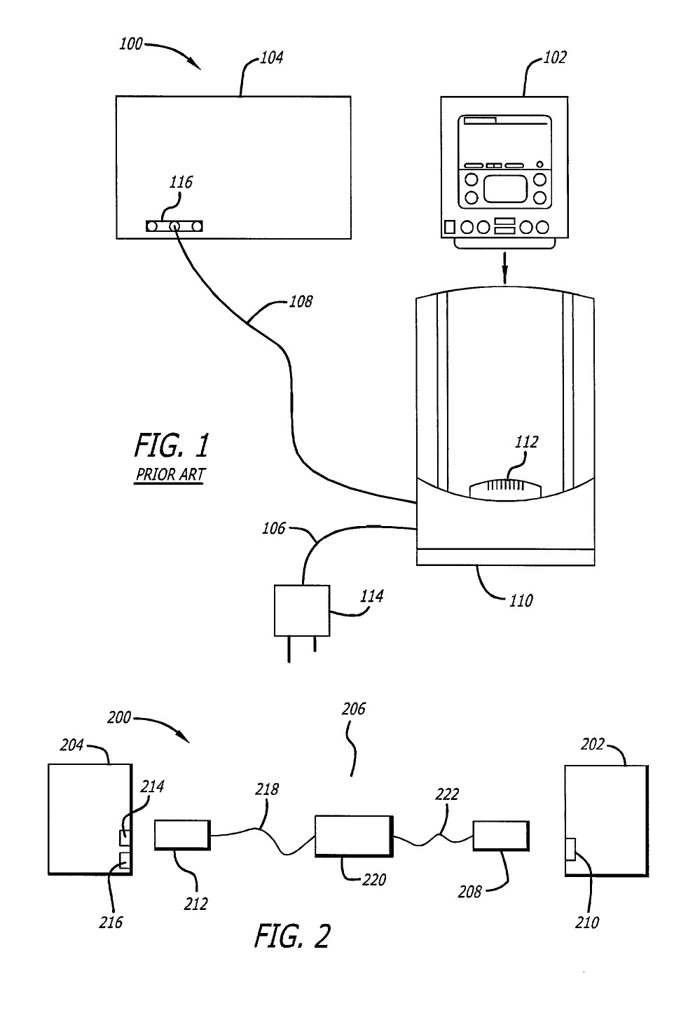

FIG. 1 illustrates a typical connection setup 100 between a PDA 102 and a computer 104, exemplary of the prior art. Generally, such connections require PDA 102 to utilize two separate operative connections: namely a power connection 106 and a data connection 108. Both connections are routed through a common device to PDA 102. This device is typically known as a synchronizing cradle 110. Synchronizing cradle 110 receives PDA 102 at interface 112. When docked in synchronizing cradle 110, PDA 102 receives power from A/C adapter 114 through power connection 106. Separately, PDA 102 receives data from computer 104 through data connection 108, which is operatively connected to computer 104 by a data connector 116. It is apparent that the typical connection setup 100 requires a number of bulky elements, including A/C adapter 114, synchronizing cradle 110, and two separate connections 106 and 108. These elements, both in quantity and in size, are cumbersome for a user to set up and operate. Particularly, the setup elements are travel prohibitive and are not desirable for establishing mobile connection setups.

A preferable method and apparatus for establishing a PDA-to-computer communication setup is described with reference to FIG. 2. FIG. 2 illustrates a compact connection setup 200 between a communication device 202 and a computer 204, exemplary of an embodiment of the present invention. In the compact setup 200, communication device 202 and computer 204 are operatively connected to a sync-charger 206 exemplary of the present invention. Communication device interface 208 connects directly to communication device 202 at 1/0 interface 210. Similarly, computer interface 212 connects directly to a computer port, such as a USB port 214 or an IEEE 1394 port 216, for example. A first cable 218 transfers data and power to and from computer 204 and signal conversion unit 220. A second cable 222 transfers data and power to and from communication device 202 and signal conversion unit 220. Data synchronization and battery power recharging then proceeds as will be described in greater detail below.

It is seen from FIG. 2 that the exemplary compact connection setup 200 requires fewer and more compact elements than prior art setups. Instead of a bulky A/C adapter, synchronizing cradle, and separate data and power connections, connector 206 comprises relatively small elements, consisting of computer and communication device interfaces 212 and 214, cables 218 and 222, and signal conversion unit 220.

Cables 218 and 222 are preferably shielded using braided shields having complete contact with metal hoods, in order to ensure compliance with typical emission specifications. In addition to transmitting signals and data between communication device interface 208 and computer interface 212, cable 218 draws power through USB interface 214 or IEEE 1394 interface 216. The power is then delivered to communication device 202 via cable 222, and is utilized by the communication device for battery recharging. It is therefore apparent that the compact exemplary sync-charger device is useful for both data transfer and for battery recharging purposes, without need for a separate synchronizing cradle or A/C adapter.

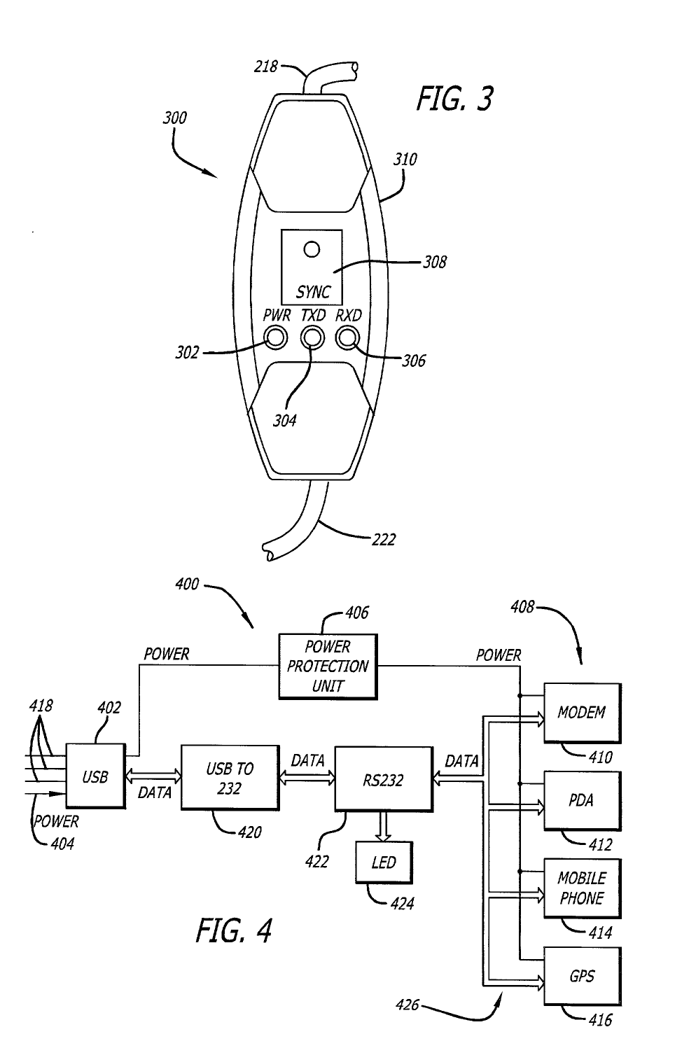

As described above, exemplary sync-charger 206 comprises a signal conversion device 300, as illustrated in FIG. 3. Signal conversion device 300 operates to convert signals for communication between a computer and a peripheral communication device such as, but not necessarily, a PDA. In addition to operating as a signal converter, signal conversion device 300 of the exemplary embodiment comprises three LED indicators 302-306 and a synchronize activation button 308. LED indicator 302 is a power indicator which operates to indicate when power is on. LED 302 will illuminate, for example, when the sync-charger is operatively connected to a computer via a USB or IEEE 1394 port, the computer is turned on, and the sync-charger is drawing power through the USB or IEEE 1394 port. LED indicator 304 is a signal transmitting indicator, and illuminates when data is being transmitted in one direction, such as from communication device interface 208 through cable 222 to computer interface 212 through cable 218. Similarly, LED indicator 306 is a signal receiving indicator, and illuminates when data is being received, or transmitted in the opposite direction. The data transfer process is triggered by depression of synchronization button 308.

Of course, it is considered to be within the scope of the invention that data or power transfer can be indicated by means other than an LED, such as an alternative light source or an audible sound, for example. Also, it is anticipated that alternative methods of activating the data transfer process may be practiced, such as flipping a switch, toggle, or other engagement mechanism. Moreover, data and power transfer can occur automatically, such that no particular activation mechanism is utilized, apart from connecting the sync charger to the peripheral device and the computer.

FIG. 4 illustrates the flow of data and power within signal conversion unit 300 as detailed by schematic 400, which is an exemplary schematic according to one embodiment of the present invention. Exemplary schematic 400 utilizes a USB connection 402 for operatively connecting the sync-charger to a computer. The signal conversion device of the sync-charger receives power through USB connection 402, as indicated at area 404. The power is drawn through the signal conversion device, and may pass through a power protection unit 406 contained therein. The power is then delivered to the communication device, which may be any of a plurality of different types, as indicated at 408. Exemplary communication devices include modem 410, PDA 412, mobile phone 414, or GPS device 416, to name a few. The signal conversion device of the sync-charger also receives data through USB connection 404, as indicated at area 418. The data is converted within the signal conversion unit to be compatible with the type of communication device used at 408. In exemplary schematic 400, the data is converted from USB to RS232 by conversion mechanism 420. As will be recognized by those skilled in the art, conversion mechanism 420 may take any of a number of forms or schematics. In the exemplary embodiment, RS232 data is then examined to determine its direction of transit, as indicated at 422. Depending on whether it is data being received by or transmitted from communication device 408, a signal is sent to the appropriate LED device 424. The LED device will be either signal transmitting indicator 304 or signal receiving indicator 306 as described above with reference to FIG. 3. After conversion occurs and the appropriate LED is activated, the data is delivered to the communication device, as indicated generally at 426. Of course, data flow is bi-directional, and may proceed in the reverse direction, from communication device 408 to the computer through USB connection 402.

Referring once again to FIG. 2, as an alternative to USB connection 402, the invention may be practiced with any of a number of communication port configurations. For example, the sync-charger cable may comprise an IEEE 1394 or other data/power interface, either instead of communication device interface 208, or directly interfaced thereto. IEE 1394 is an external bus standard that supports data transfer rates of up to 400 Mbps. Other types of interfaces that may be practiced with the present invention include the equivalent of Recommended Standard-232C (RS-232C) interface, adapted to comprise additional power feeding pins. Power feeding pins refer to pins that are designated to accept power from the computer and deliver the power to the PDA for re-charging. RS-232C is a standard approved by the Electronic Industries Association (EIA) for connecting serial devices. RS-232 connectors do not contain power transfer capabilities. However, certain peripheral devices use modified versions of the RS-232 connectors, comprising USB, RS-232 and power feeding pins in a single interface. For example, HandSpring's Visor PDA utilizes a connector having 8 pins. Two pins, D+ and D−, are used for USB data interface; three pins, TXD, RXD, GND, are used for RS-232 interface; one pin, HS1, is used for data synchronizing; one pin, VDOCK, is used for re-charging power input to the PDA; and one pin, KBD, is reserved for other uses. Other interfaces and connectors will be apparent to those skilled in the art, and are considered to be within the scope of the present invention.

The foregoing description of the preferred embodiments of the invention has been presented for the purposes of illustration and description. It is not intended to be exhaustive or to limit the invention to the precise form disclosed. Many modifications and variations are possible in light of the above teaching. For example, the term “PDA” is intended to encompass any computer peripheral device and the term “PDA interface” is intended, similarly, to encompass any suitable interface for said computer peripheral device. The invention is also not limited to being used for synchronizing data between two machines. Rather, the invention may be used for different types of data transfer and power supply for a wide array of computers and computer peripheral devices. Further, the invention is not limited to recharging battery power, and can be used to deliver real-time operational power to recharge power retention devices other than batteries, such as capacitors and the like.

It is intended that the scope of the invention be limited not by this detailed description, but rather by the claims appended hereto.

What is claimed is:

1. A signal conversion device operatively connected between an information device and a computer, said signal conversion device comprising:
a first terminal connector operatively connected to a computer's interface port;
a second terminal connector operatively connected to said information device's interface port;
a signal conversion unit located between said first terminal connector and said second terminal connector; and
said signal conversion device configured to convert a signal for receipt by said first terminal connector and said second terminal connector, and to provide electricity from said first terminal connector, through said second terminal connector, to said information device.

2. The signal conversion device of claim 1 wherein said first terminal connector comprises a USB interface.

3. The signal conversion device of claim 1 wherein said first terminal connector comprises an IEEE 1394 interface.

4. The signal conversion device of claim 1 wherein said first terminal connector comprises a RS-232 interface, said RS-232 interface further comprising a power feeding pin.

5. The signal conversion unit of claim 1 further comprising:
a power indicator;
a signal transmitting indicator; and
a signal receiving indicator.

6. The signal conversion unit of claim 5 further comprising a synchronize activation button.

7. The signal conversion unit of claim 1 wherein said information device is a handheld computer.

8. The signal conversion unit of claim 1 wherein said information device is a modem.

9. The signal conversion unit of claim 1 wherein said information device is a Global Positioning System device.

10. The signal conversion unit of claim 1 wherein said information device is a mobile telephone.

11. A signal conversion unit comprising:
an input port for receiving data and power;
a data converter; and
an output port for transmitting data and power;
wherein said signal conversion unit is configured to receive data and power, convert said data, and transmit said converted data and said power.

12. The signal conversion unit of claim 11, further comprising a synchronize activation button.

13. The signal conversion unit of claim 11, further comprising a power protection unit.

14. A method of synchronizing data stored in a peripheral device with data stored on a computer, said method comprising:
operatively connecting a first connector of a signal conversion device to a peripheral device interface;
operatively connecting a second connector of said signal conversion device to a computer port; and
activating said signal conversion device, wherein said activating causes data to be transmitted between said peripheral device and said computer.

15. The method of claim 14 wherein said activating further causes power to be transmitted between said peripheral device and said computer.

16. The method of claim 14 wherein said activating comprises depressing a button located on said signal conversion device.
